(19) United States
(12) Patent Application Publication
(10) Pub. No.: US 2004/0228426 A1
(43) Pub. Date: Nov. 18, 2004

(54) Apparatus and method for cancelling narrow-band interference in a mobile communication system

(76) Inventors: Jeong-Tae Oh, Seoul (KR); Jae-Hyok Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/843,415

(22) Filed: May 12, 2004

(30) Foreign Application Priority Data
May 12, 2003 (KR) 2003-29889

(51) Int. Cl. H04K 1/00

(52) U.S. Cl. 375/346

(57) ABSTRACT

A narrow-band interference cancellation apparatus and method for use in a broadband mobile communication system are disclosed. The apparatus and method comprise a detector for detecting narrow-band interference contained in a digital reception signal, classifying the detected narrow-band interference into Infinite Impulse Response (IIR) and Finite Impulse Response (FIR) interference signals according to a predetermined reference value, and generating control signals in response to the classified narrow-band interference signals and center frequencies associated with the control signals. The apparatus and method also comprise a first interference cancellation filter for responding to the control signals generated by the classified FIR narrow-band interference signal, and canceling the FIR narrow-band interference signal using the center frequencies. The apparatus and method further comprise a second interference cancellation filter for responding to the control signals generated by the classified IIR narrow-band interference signal, and canceling the IIR narrow-band interference signal using the center frequencies.

### PRIORITY

This application claims the benefit under 35 U.S.C. § 119(a) of an application entitled “APPARATUS AND METHOD FOR CANCELLING NARROW-BAND INTERFERENCE IN MOBILE COMMUNICATION SYSTEM”, filed in the Korean Intellectual Property Office on May 12, 2003 and assigned Ser. No. 2003-29889, the entire contents of which are incorporated herein by reference.

### BACKGROUND OF THE INVENTION

1. Field of the Invention

The present invention relates to an apparatus and method for cancelling interference in a broadband mobile communication system. More particularly, the present invention relates to an apparatus and method for controlling a base station to remove narrow-band interference contained in a broadband reception signal.

2. Description of the Related Art

The allocation of frequency bands have provided mobile terminals with wireless communication services. However, the performance of mobile communication systems suffer from interference. In a worst case scenario, the interference can result in a lack of communication. Thus, there is a need for a means of overcoming this interference.

Mobile communication systems are usually affected by two types of interference. The interference comprises same frequency interference and adjacent frequency interference. Same frequency interference is classified into interference between Base Stations (BSs) using the same frequency and interference from other systems such as unauthorized wireless stations. Adjacent frequency interference is classified into interference between BSs contained in the same system using an adjacent frequency and interference between adjacent systems.

The worst type of interference generated by current broadband wireless communication systems may be narrow-band interference, which is generated by other systems using the same frequency resources. Narrow-band interference generated in the mobile communication base station (BS) system may encounter system performance deterioration and communication interruption. Several methods have been widely used to remove such narrow-band interference, and their detailed descriptions will hereinafter be described.

The first method uses a narrow-band interference cancellation filter to remove narrow-band interference. Specifically, upon receiving a narrow-band interference signal, the first method controls a high-speed interference signal detection receiver to detect a frequency of the received narrow-band interference signal, and converts the detected frequency into an Intermediate Frequency (IF) signal. Thereafter, the IF signal removes the interference signal using a specified filter, such that it can be restored to an original frequency. The aforementioned first method has disadvantages in that it results in a device heavy in weight and large in size, and the device unavoidably consumes a large amount of power as compared to other devices.

The second method adapts a specified filter and a Fast Fourier Transform (FFT) scheme to suppress narrow-band interference. Specifically, the second method adapts a specific filter in a carrier frequency to suppress an interference signal having a high power level, quantizes the other interference signal having a low power level, and suppresses the other interference signal having the low power level signal using FFT and Inverse Fast Fourier Transform (IFFT) schemes. However, the aforementioned second method must use different techniques according to the power levels of the interference signal, resulting in a complicated device. Also, the second method must perform FFT and IFFT schemes to remove the narrow-band interference, resulting in increased delay of a reception signal.

The third method adapts an adaptive digital filter to suppress narrow-band interference. Specifically, the third method reduces a frequency of an input signal indicative of a carrier frequency, controls a power gain of the reduced frequency, and quantizes the power gain such that it converts an analog signal into a digital signal. Finally, the third method detects an interference signal from the digital signal. The detected interference signal is removed by an adaptive digital Infinite Impulse Response (IIR) filter. However, the aforementioned third method adapts the IIR filter adaptive to an interference signal to remove narrow-band interference, such that it unavoidably increases system complexity to improve system stability, resulting in a longer delay time for stable adaptive operations.

In order to solve the aforementioned problems, an adaptive digital Finite Impulse Response (FIR) filter having high stability has recently been developed to remove a FIR interference signal having a prescribed bandwidth. However, provided that there are several narrow-band signals having different power levels at the same time, a plurality of FIR filters for removing interference among several narrow-band signals must also be used at the same time, such that a large number of tabs to operate the FIR filters is required. In addition, provided that a plurality of FIR filters are used at the same time to remove a plurality of narrow-band interference, the amount of noise and system complexity are unavoidably increased, resulting in performance deterioration due to the increased amount of noise and a complicated device due to the high system complexity.

### SUMMARY OF THE INVENTION

The present invention overcomes the above mentioned problems, and it is an object of the present invention to provide a narrow-band interference cancellation apparatus and method for removing narrow-band interference from a broadband signal to prevent a communication interruption problem from being generated by a narrow-band interference signal in a mobile communication system.

It is another object of the present invention to provide a narrow-band interference cancellation apparatus and method for converting a reception signal of a mobile communication system into a digital signal, and decimating the digital signal to create a baseband signal to remove interference from the baseband signal.

It is yet another object of the present invention to provide a narrow-band interference cancellation apparatus and method for removing narrow-band interference having different power levels using a mixed filter configuration.

It is yet another object of the present invention to provide a narrow-band interference cancellation apparatus and method capable of correctly detecting an input narrow-band interference and correctly controlling an interference signal filter such that it can effectively maintain a mixed configuration.

In accordance with one aspect of the present invention, the above and other objects can be accomplished by the provision of a narrow-band interference cancellation apparatus for use in a broadband mobile communication system. The apparatus comprises a detector for detecting narrow-band interference contained in a digital reception signal, classifying the detected narrow-band interference into Infinite Impulse Response (IIR) and Finite Impulse Response (FIR) interference signals according to a predetermined reference value, and generating control signals in response to the classified narrow-band interference signals and center frequencies associated with the control signals. The apparatus also comprises a first interference cancellation filter for responding to the control signals generated by the classified FIR narrow-band interference signal, and canceling the FIR narrow-band interference signal using the center frequencies. The apparatus further comprises a second interference cancellation filter for responding to the control signals generated by the classified IIR narrow-band interference signal, and canceling the IIR narrow-band interference signal using the center frequencies.

In accordance with another aspect of the present invention, there is provided a method for canceling narrow-band interference of a digital reception signal received in a broadband mobile communication system with an interference canceller composed of a detector and first and second interference cancellation filters each composed of one or more different interference cancellation filters. The method comprises detecting, by the detector, narrow-band interference contained in the digital reception signal, and classifying the detected narrow-band interference into an IIR interference signal and a FIR interference signal according to a predetermined reference value. The method also comprises outputting, by the detector, control signals responsive to the classified interference signals and center frequencies associated with the control signals to the interference cancellation filters. The method further comprises responding to the control signals by the first and second interference cancellation filters, filtering the classified narrow-band interference signals using individual center frequencies.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an apparatus for controlling a mobile communication system to remove narrow-band interference from a baseband signal in accordance with an embodiment of the present invention;

FIG. 2 is a detailed block diagram illustrating a decimation filter shown in FIG. 1 in accordance with an embodiment of the present invention;

FIG. 3 is a block diagram illustrating an interference canceller shown in FIG. 1 in accordance with an embodiment of the present invention;

FIG. 4 is a block diagram illustrating a coefficient generator for use in the interference cancellation filter shown in FIG. 3 in accordance with an embodiment of the present invention;

FIG. 5 is a view illustrating power levels of a narrow-band interference signal detected by a detector in accordance with an embodiment of the present invention;

FIG. 6 is a detailed block diagram illustrating a detector shown in FIG. 3 in accordance with an embodiment of the present invention;

FIG. 7 is an exemplary view illustrating a cancellation table shown in FIG. 6 in accordance with an embodiment of the present invention; and

FIG. 8 is a flow chart illustrating operations of a cancellation table in accordance with a preferred embodiment of the present invention.

In the drawings, the same or similar elements are denoted by the same reference numerals even though they are depicted in different drawings.

### DETAILED DESCRIPTION OF THE PREFERRED EMBODIMENTS

Embodiments of the present invention will now be described in detail with reference to the accompanying drawings. In the following description, a detailed description of known functions and configurations incorporated herein will be omitted for conciseness.

In the case of generating a plurality of narrow-band interference signals having different power levels at the same time, an apparatus and method of the present invention can effectively remove the narrow-band interference signals, and their detailed descriptions will hereinafter be described with reference to the accompanying drawings.

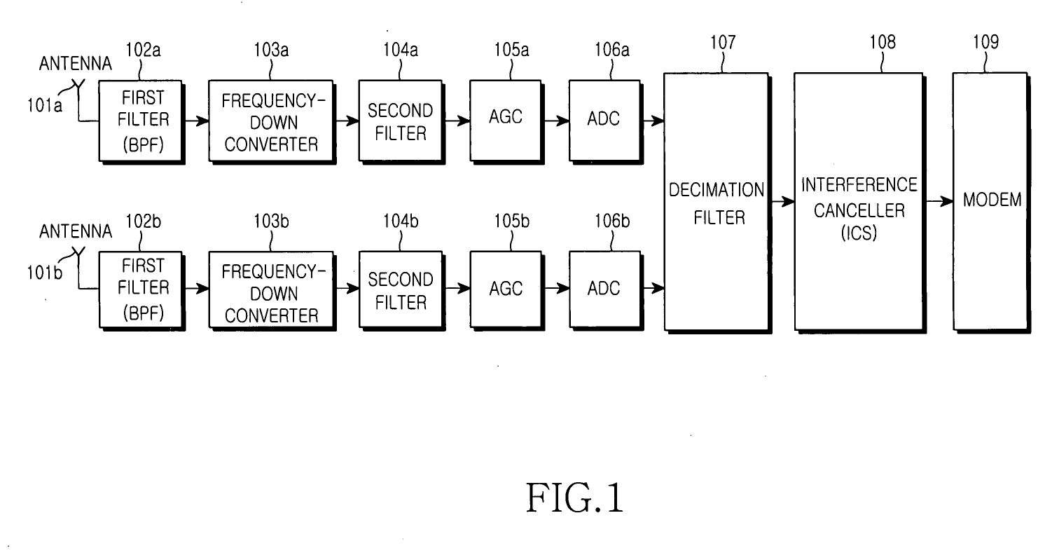

FIG. 1 is a block diagram illustrating an apparatus for controlling a mobile communication system to remove narrow-band interference from a baseband signal in accordance with an embodiment of the present invention.

Referring to FIG. 1, first filters 102a and 102b each act as a bandpass filter, and filter a desired reception-band signal from among signals received in antennas 101a and 101b. Frequency-down converters 103a and 103b perform frequency-down conversion of the reception-band signals generated from the first filters 102a and 102b such that the reception-band signals are converted into specific-band signals. Second filters 104a and 104b receive the frequency-down conversion signals from the frequency-down converters 103a and 103b, and filter the received frequency-down conversion signals in a more precise frequency band. Automatic Gain Controllers (AGSs) 105a and 105b control gains of output signals of the second filters 104a and 104b. Analog to Digital Converters (ADCs) 106a and 106b receive AGC-controlled analog signal from the AGCs 105a and 105b, and convert the received AGC-controlled analog signal into digital signals each having sampling values in association with one symbol.

In the case of performing a reception (Rx) diversity function in a mobile communication system, a reception path ranging from the first filters 102a and 102b to the digital converters 106a and 106b may comprise a plurality of paths. FIG. 1 shows an exemplary mobile communication system for adapting a reception diversity scheme to duplicate an antenna and a reception path. It should be noted that if the mobile communication system does not use reception diversity the system can use an interference cancellation device.

The decimation filter 107 decimates samples of the converted digital signals according to predetermined decimation rates. The interference canceller 108 detects interference from the filter-decimated signal, and removes the detected interference. The MODEM (Modulator and Demodulator) 109 receives a baseband signal having no interference from the interference canceller 108, and demodulates the received baseband signal.

Operations for removing narrow-band interference will hereinafter be described with reference to FIG. 1. Signals received over the antennas 101a and 101b are Radio Frequency (RF) signals. The first filters 102a and 102b filter only the desired frequency bands from the received RF signals.

The frequency-down converters 103a and 103b perform frequency-down conversion of the RF signals filtered by the first filters 102a and 102b, and thereby convert the RF signals into specific-band signals. The frequency-down conversion must be performed to prevent signal distortion from being generated in signal characteristics when converting a high-frequency RF signal into a baseband signal in one step. Therefore, the RF signal is converted into an Intermediate Frequency (IF) signal ranging from the frequency band of the RF signal to the baseband signal, and the IF signal is then converted into the baseband signal.

The second filters 104a and 104b receive band-pass-filtered signals from the first filters 102a and 102b, and more precisely filter the received band-pass-filtered signals. The AGCs 105a and 105b constantly maintain the power intensity levels of output signals of the second filters 104a and 104b, and the digital converters 106a and 106b convert the AGC-controlled analog signals into high-speed digital signals.

The high-speed digital signals have many sampling values in association with one symbol, such that the decimation filter 107 decimates the sampled signals to allow the interference canceller 108 to easily process narrow-band interference. Upon receiving the decimated result signal from the decimation filter 107, the interference canceller 108 removes the narrow-band interference using the decimated result signal. The MODEM 109 receives the output signal from the interference canceller ICS 108, and demodulates the received output signal of the interference canceller 108.

The narrow-band cancellation device for use in a mobile communication system converts its reception signal into a digital signal as shown in FIG. 1. The narrow-band cancellation device decimates the digital-converted data, so that the digital-converted data is converted into a baseband signal and interference is removed from the baseband signal. Therefore, the narrow-band cancellation device has less material cost and occupies a smaller space as compared to the conventional method capable of either removing interference from an RF band or removing interference from the RF band- and the baseband-ranges at the same time.

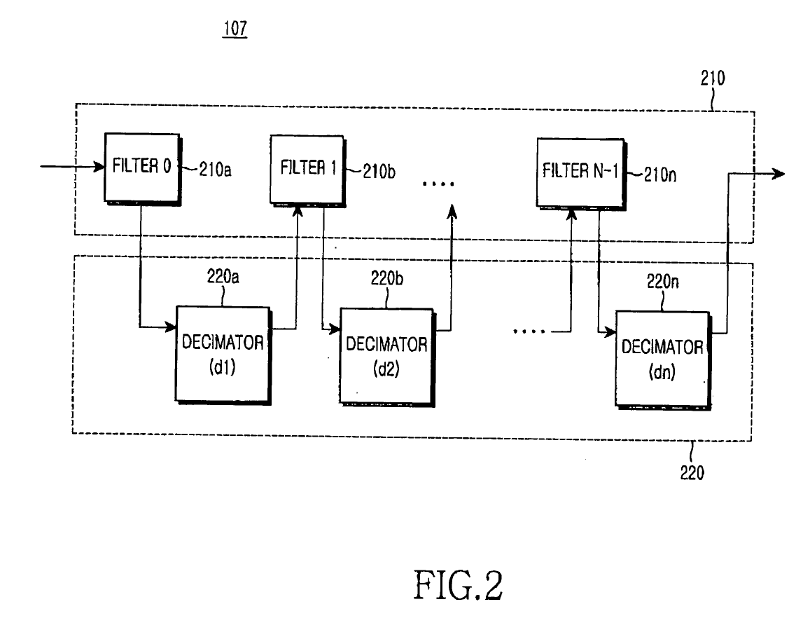

FIG. 2 is a detailed block diagram illustrating the decimation filter shown in FIG. 1 in accordance with an embodiment of the present invention.

Referring to FIG. 2, the decimation filter 107 includes filter 210 comprising a plurality of filters 210a up to 210n and decimator 220 comprising a plurality of decimators 220a up to 220n. The filters 210a up to 210n and the decimators 220a up to 220n are connected in series to each other in the form of an interlaced structure.

The first filter 210a contained in the filters 210a up to 210n receives the output signal of the digital converter 106, and corrects errors generated in a process for reducing the number of signals. The first decimator 220a receives the output signal of the first filter 210a, reduces the number of input signals using a prescribed decimation rate d1, and outputs the decimation-result signal to the second filter 210b. The filters 210b up to 210n and the remaining decimators 220b up to 220n are operated in the same manner as in the first filter 210a and the first decimator 220a, such that they can reduce the number of input signals received from a previous filter. The last output signal of the decimation filter 107 acts as an input signal of the interference canceller 108.

Operations of the decimation filter 107 will hereinafter be described.

In case of a Code Division Multiple Access (CDMA) system, assuming that the output signals of the ADCs 106a and 106b are each comprise 64 samples for every chip, decimation rates of three decimators 220a-220c are determined to be d1=8, d2=2, and d3=3, respectively, the decimator 220a performs a decimation function at the rate of d1=8, such that the number of output samples of the decimator 220a is denoted by ‘64/8=8’, resulting in a reduction of the number of output samples. Therefore, the number of final output samples decimated by the decimators 220b-220c is denoted by ‘64/8/2/2=2’.

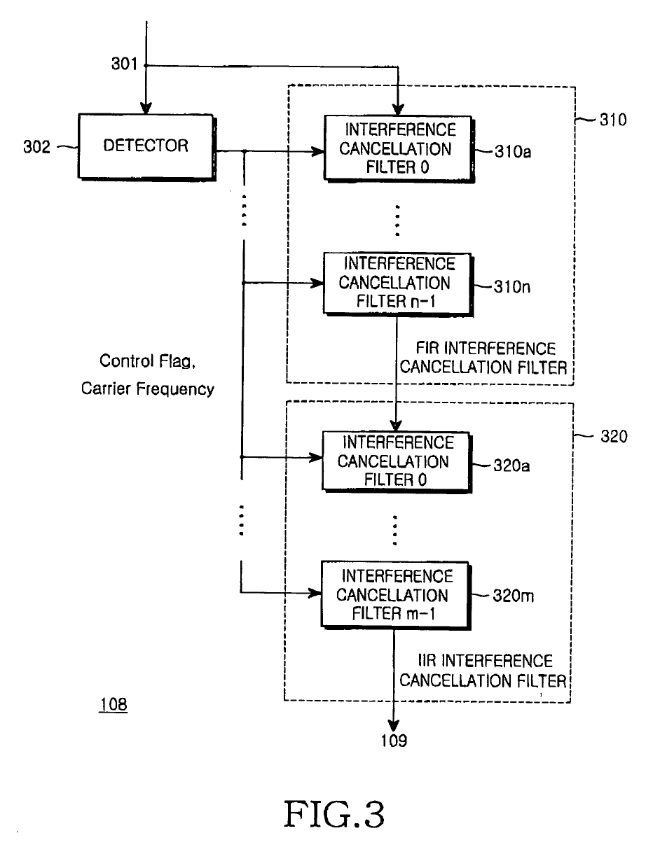

The decimation rates d1-dn of the decimators 220a up to 220n are determined to be suitable for the number of output samples of the ADCs 106a and 106b and the number of input samples of the interference canceller 108. Operations of the interference canceller 108 capable of receiving the output signal of the last output terminal of the decimation filter will hereinafter be described with reference to FIG. 3.

FIG. 3 is a block diagram illustrating the interference canceller shown in FIG. 1 in accordance with an embodiment of the present invention.

Referring to FIG. 3, the interference canceller 108 includes a detector 302 for detecting narrow-band interference from the digital-converted signal, and Finite Impulse Response (FIR) comprising a plurality of interference cancellation filters 310a up to 310n and Infinite Impulse Response (FIR) 320 comprising 320a up to 320m which can classify the detected narrow-band interference into IIR interference and FIR interference, and can remove the detected narrow-band interference according to the IIR and FIR interference. In this case, the interference cancellation filters 310a up to 310n are adaptive digital FIR filters capable of removing FIR narrow-band interference. The interference cancellation filters 320a up to 320m are adaptive digital IIR filters capable of removing IIR narrow-band interference.

The input signals of the interference canceller 108 are transmitted to the first FIR filter 310a. The detector 302 determines whether narrow-band interference exists in a received input signal, determines the number of narrow-band interferences if it is determined that such narrow-band interference exists in the received input signal, and detects a center frequency and power information of the narrow-band interference. The detector 302 configures necessary information upon receipt of the detection result, and transmits the configured information to the FIR filter 310 and the IIR filter 320. In this case, the necessary information includes on and off information, power level information of narrow-band interference, and center frequency information, and so on, in association with the FIR filter 310 and the IIR filter 320.

The FIR filter 310 and the IIR filter 320 receive pre-assigned ON and OFF flag information from the detector 302 according to the result of the comparison between power levels of the narrow-band interference. In this case, the interference cancellation filter having received the ON flag calculates a coefficient of the interference cancellation filter using the center frequency and power level information of given narrow-band interference, and performs a filtering operation using the coefficient. Otherwise, the interference cancellation filter having received the OFF flag bypasses the input signal. Exemplary operations of the interference canceller will hereinafter be described in detail.

If the detector 302 detects one FIR interference signal and three IIR interference signals from its reception signal, it transmits the ON flag to the first FIR filter 310a, and the first to third IIR filters 320a-320c. The detector 302 transmits the ON flag and the center frequency and power level information of narrow-band interference signals to the FIR filter 310a and the IIR filters 320a-320c. The detector 302 transmits the OFF flag to the remaining FIR filters 310b-310n and the IIR filters 320d-320m. The first FIR filter 310a and the first to third IIR filters 320a-320c having received the ON flag calculate an interference cancellation filtering coefficient using center frequencies and power levels of given narrow-band interference signals, and perform a filtering operation using the calculated interference cancellation filtering coefficient. In this case, the method for calculating the interference cancellation filtering coefficient is well known to those skilled in the art, such that their detailed description will herein be omitted for purposes of conciseness.

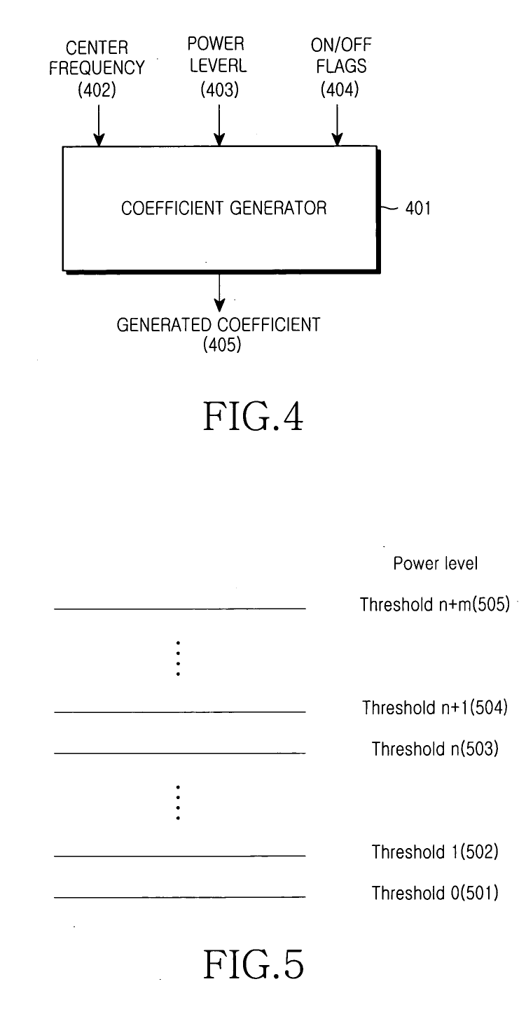

The interference cancellation filters having received the OFF flag bypass their input signals. The coefficient generator for calculating the coefficient using the interference cancellation filters will hereinafter be described with reference to FIG. 4.

The coefficient generator 401 receives the center frequency 402, the power level 403, and the ON/OFF flags 404 on the basis of individual narrow-band interference information detected by the detector 302 of FIG. 3. Then, the coefficient generator 402 determines whether a coefficient is generated by the ON/OFF flags 404. Upon receiving the ON flag, the coefficient generator 401 determines basic coefficients of FIR and IIR interference cancellation filters 310 and 320 according to the power level 403, calculates a characteristic coefficient using the center frequency 402, and generates the calculated characteristic coefficient to filter the generated coefficient 405.

Narrow-band interference power levels detected by the detector in the aforementioned interference canceller will hereinafter be described with reference to the accompanying drawings.

FIG. 5 is a view illustrating power levels of a narrow-band interference signal detected by the detector in accordance with an embodiment of the present invention.

Referring to FIG. 5, first and n-th power levels (Threshold 1-Threshold n) are indicative of use ranges of the IIR filter 320, and n+1-th to n+m-th power levels (Threshold n+1—Threshold n+m) are indicative of use ranges of the FIR filter 310.

The detector 302 determines a maximum power-level reference (Threshold n) 503 of narrow-band interference removable by the IIR filter 320. Therefore, a power level higher than the maximum power-level reference 503 is assigned to the FIR filter 310, and a power level tower than the maximum power-level reference 503 is assigned to the IIR filter 320. The detector 302 transmits power-level information associated with narrow-band interference power levels (Threshold 0−n) to the coefficient generator 401 of FIG. 4, such that the power-level information can be adapted to determine basic coefficients suitable for individual power levels of the IIR filter 320. The detector 302 transmits narrow-band interference power-level information (Threshold n+1−n+m) to the FIR filter 310, such that the narrow-band interference power-level information can be adapted to determine basic coefficients suitable for individual power levels of the FIR filter 310. The described method for determining the maximum power-level reference is essential for interference cancellation filters to effectively remove narrow-band interference signals.

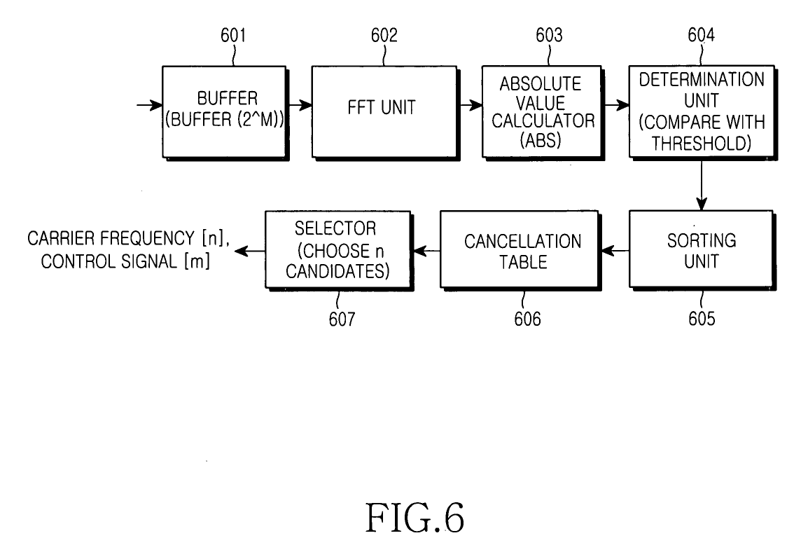

FIG. 6 is a detailed block diagram illustrating the detector shown in FIG. 3 in accordance with an embodiment of the present invention.

Referring to FIG. 6, an input signal of the interference canceller is stored in the buffer 601 during a predetermined period of time, and the FFT unit 602 performs FFT conversion of the input signal. The absolute value calculator (ABS) 603 calculates absolute values of the FFT-conversion signals. In more detail, the ABS 603 calculates energy magnitudes. The determination unit 604 compares the absolute values with a threshold value, and selects values higher than the threshold value. Also, the determination unit 604 determines power levels of frequency components that were detected to control interference cancellation filters. The determined power levels are adapted to operate the following cancellation table 606. After operating the cancellation table 606, a required interference cancellation filter can be appropriately selected according to the determined power levels. In this case, the interference cancellation filter can also be detected by the determination unit 604. The threshold value is adapted to detect an interference frequency signal having relatively-high energy as compared to a signal to be received. Specifically, the output signals of the determination unit 604 are considered to be interference signals.

The sorting unit 605 arranges values higher than the determined threshold value in order of energy level in such a way that it configures the sorting list. Specifically, the sorting unit 605 arranges such values higher than the determined threshold value in order of narrow-band interference causing the most fatal problem in a system.

The cancellation table 606 determines narrow-band signals required to be actually cancelled from among the sorting signals generated from the sorting unit 605, such that it configures the cancellation table. The cancellation table 606 will now be described in detail.

The selector 606 selects N candidates from among output signals, which are generated in order of power magnitudes according to the power level determined by the determination unit 604, according to the number of interference cancellation filters 310a up to 310n and 320a up to 320m. Upon receiving the output signals of the cancellation table, the selector 606 configures the center frequency 402, the power level 403, and the ON/OFF flag 404 to be transmitted to individual interference cancellation filters 310a up to 310n and 320a up to 320m. In this case, the cancellation table 606 will now be described in detail.

Table configurations and individual variables according to power levels of the cancellation table 606 are determined by characteristics of the interference cancellation filters for removing interference. If using interference cancellation filters 310 and 320 suitable for power levels of the detection signal selected from among narrow-band interference signals arranged in the sorting unit 605, signals are suppressed and cancelled even in an undesired peripheral frequency areas due to unique characteristics of the interference cancellation filters, such that the cancellation table 606 is designed to use these signal suppression/cancellation operations.

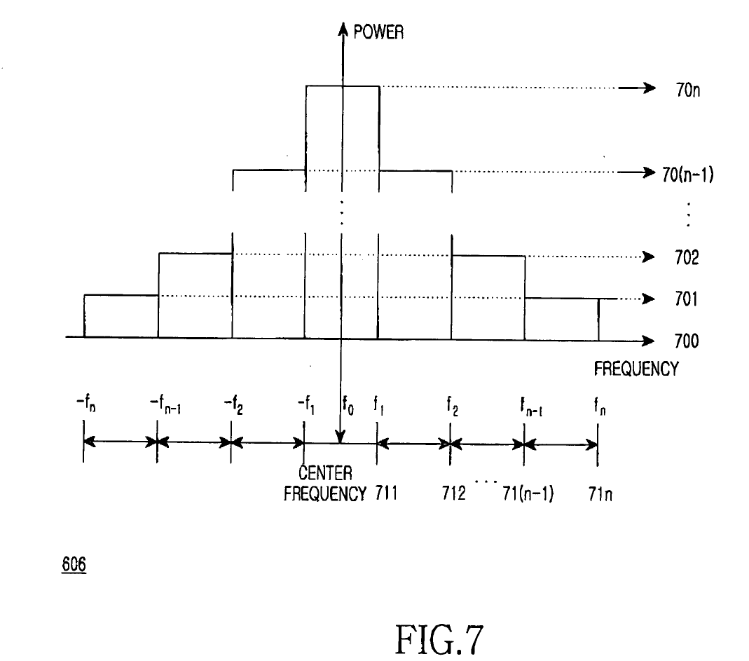

Upon receiving interference signals detected from nearby frequencies of the center frequency of a predetermined interference signal to which a specific interference cancellation filter must be used, the cancellation table 606 selects one or more interference signals sufficiently removable by a specific interference cancellation filter from among the received interference signals, and excludes the selected interference signals from a predetermined sorting table. The aforementioned process is determined using power- and center frequency-information of nearby interference signals. The cancellation table 606 prevents the misuse of the limited number of interference cancellation filters, and also prevents performance deterioration generated when using several interference cancellation filters. Exemplary filtering characteristics of the interference cancellation filter will hereinafter be described with reference to FIG. 7.

FIG. 7 is an exemplary view illustrating the cancellation table shown in FIG. 6 in accordance with an embodiment of the present invention. In FIG. 7, a horizontal axis 700 is indicative of a frequency, and a vertical axis is indicative of a power value.

Referring to FIG. 7, the cancellation table 606 is indicative of a signal suppression degree suppressed in nearby frequencies of the center frequency f₀ when a corresponding interference cancellation filter is applied to the center frequency f₀. Specifically, a signal less than a specific power level ‘A’ 70(n) is suppressed in the range from a frequency −f₁ to the other frequency f₁ on the basis of the center frequency f₀, and a signal less than a specific power level ‘B’ 70(n−1) is suppressed in the range from a frequency −f₂ to the other frequency f₂ on the basis of the center frequency f₀. In this manner, a signal less than a specific power level ‘C’ 702 is suppressed in the range from a frequency −fₙ₋₁ the other frequency fₙ₋₁ the basis of the center frequency f₀, and a signal less than a specific power level ‘D’ 701 is suppressed in the range from a frequency −fₙ to the other frequency fₙ on the basis of the center frequency f₀.

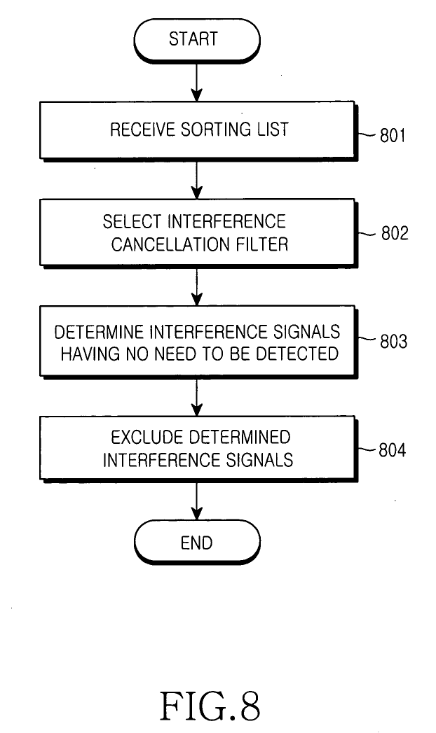

Detailed operations of the cancellation table 606 will hereinafter be described with reference to FIG. 8.

FIG. 8 is a flow chart illustrating operations of the cancellation table in accordance with an embodiment of the present invention.

Referring to FIG. 8, the cancellation table 606 receives the sorting list arranged in descending numerical order from the sorting unit 605 at step 801, and acquires the center frequency of the first interference signal having the highest power level and power-level information adapted to determine an interference cancellation filter from the sorting list.

The cancellation table 606 selects an interference cancellation filter corresponding to the acquired power-level information at step 802. The cancellation table 606 searches for interference signals that do not need to be detected from among interference signals contained in the sorting list according to characteristic information of the selected interference cancellation filter at step 803. For example, when using the filtering characteristics of FIG. 7, the cancellation table 606 searches for an interference signal less than a specific power level ‘A’ 70n in the range from a frequency −f₁ to the other frequency f₁ on the basis of the center frequency f₀ of the first interference signal contained in several interference signals. In this manner, the cancellation table 606 searches for interference signals less than predetermined power levels B-D contained in the frequency ranges −f₂₋fₙ and f₂₋fₙ. Thereafter, the cancellation table 606 excludes the searched interference signals from the sorting list at step 804, resulting in the creation of cancellation table.

In this manner, the cancellation table 606 transmits information associated with narrow-band interference signals of the sorting table in which some narrow-band interference signal that do not need to be detected are not contained to the selector 607. Therefore, the selector 607 having received the information selects N candidates according to the number of assigned interference cancellation filters, and outputs a carrier frequency and control signals (e.g., a power level and an ON/OFF flag) to individual interference cancellation filters 310 and 320. Therefore, the interference cancellation filter having received the ON flag removes narrow-band interference using the carrier frequency and the control signals.

As apparent from the above description, the embodiments of the present invention convert an analog signal into a high-speed digital signal, convert the high-speed digital signal into a baseband signal using decimation filters, and removes narrow-band interference signals from the baseband signal, resulting in more precise control operations and a simplified configuration. The embodiments of the present invention can detect more precise signal information using the interference signal detector, and can simplify the interference cancellation filter using an effective detection algorithm. Furthermore, the embodiments of the present invention can perform a stable interference cancellation function using an interference canceller composed of a plurality of mixed interference cancellation filters between FIR and IIR filters.

Although the present invention has disclosed three embodiments for illustrative purposes, the present invention can also be applied to other methods, for example, a monitoring setup method and an execution method, and so on.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A narrow-band interference cancellation apparatus for use in a broadband mobile communication system, comprising:
a detector configured to detect narrow-band interferences contained in a digital reception signal, classify the detected narrow-band interferences into first and second interference signals according to a predetermined reference value, and generate control signals in response to the classified narrow-band interference signals
a first interference cancellation filter configured to responde to the control signals generated by the classified first narrow-band interference signals, and cancel the first narrow-band interference signals; and
a second interference cancellation filter configured to respond to the control signals generated by the classified second narrow-band interference signals, and cancel the second narrow-band interference signals.

2. The apparatus according to claim 1, wherein the control signal contains center frequency, ON/OFF flag and power level information.

3. The apparatus according to claim 1, wherein the canceled first narrow-band interference signals is canceled based upon a center frequency,

4. The apparatus according to claim 1, wherein the canceled second narrow-band interference signals is canceled based upon a center frequency,

5. The apparatus according to claim 1, wherein the detector comprises:
a Fast Fourier Transform (FFT) unit configured to perform FFT conversion of the digital reception signal;
a determination unit configured to compare energy magnitudes of the FFT-conversion signals with a predetermined threshold value, and determining signals having energy magnitudes higher than the threshold value to be narrow-band interference signals;
a sorting unit configured to receive the narrow-band interference signals from a determination unit, and arrange the received narrow-band interference signals in order of their magnitudes;
a cancellation table configured to receive the arranged narrow-band interference signals from the sorting unit, and determine interference signals to be removed from among the received narrow-band interference signals according to the characteristics of the first and second interference cancellation filters; and
a selector configured to classify the narrow-band interference signals determined by the cancellation table into an first interference signal and an second interference signal, and output corresponding control signals to the first and second interference cancellation filters.

6. The apparatus according to claim 5, wherein the cancellation table adapts the first and second interference cancellation filters to other nearby detection interference signals to remove at least one cancelable interference signal, and determines narrow-band interference signals to be cancelled.

7. The apparatus as set forth in claim 5, wherein the selector sequentially selects first and second interference signals equal to the number of interference cancellation filters contained in the first and second interference cancellation filters from among the arranged interference signals according to the order of magnitudes of the first and second interference signals.

8. The apparatus according to claim 5, wherein the cancellation table removes the interference signals using frequency characteristics of the first and second interference cancellation filters.

9. The apparatus according to claim 1, wherein the first interference cancellation filter comprises adaptive digital FIR(Finite Impulse Response) filters.

10. The apparatus according to claim 1, wherein the second interference cancellation filter comprises adaptive digital IIR(Infinite Impulse Response) filters.

11. A method for canceling narrow-band interference, comprising the steps of:
detecting, narrow-band interferences contained in a digital reception signal,
classifying the detected narrow-band interferences into an first interference signals and a second interference signals according to a predetermined reference value;
outputting, control signals responsive to the classified interference signals and
cancelling the classified interference signals according to the control signals.

12. The method according to claim 11, wherein the control signal contains center frequency, ON/OFF flag and power level information.

13. The method according to claim 11, wherein the canceled first and second narrow-band interference signals is canceled based upon a center frequency.

14. The method according to claim 8, wherein the outputting step further comprises:
performing Fast Fourier Transform (FFT) conversion of the digital reception signal;
comparing energy magnitudes of the FFT-conversion signals with a predetermined threshold value, and determining signals having energy magnitudes higher than the threshold value to be narrow-band interference signals;
arranging the received narrow-band interference signals in order of their magnitudes;
determining narrow-band interference signals to be actually removed from among the arranged narrow-band interference signals; and
classifying the determined narrow-band interference signals into a first interference signals and an second interference signals, and outputting corresponding control signals to the first and second interference cancellation filters.

15. The method according to claim 14, wherein the determining step further comprises:
adapting the first and second interference cancellation filters to other nearby detection interference signals to remove at least one cancelable interference signal, and determining narrow-band interference signals to be cancelled.

16. The method according to claim 14, further comprises:
sequentially selecting FIR and IIR interference signals equal to the number of interference cancellation filters contained in the first and second interference cancellation filters from among the arranged interference signals according to the order of magnitudes of the FIR and IIR interference signals.

17. The method according to claim 14, wherein the classifying step further comprises:
canceling the interference signals using band-filtering characteristics of individual interference cancellation filters.

18. The method according to claim 11, wherein the first interference cancellation filter comprises adaptive digital FIR filters, and the second interference cancellation filter is composed of adaptive digital IIR filters.
